(19) United States
(12) Patent Application Publication
(10) Pub. No.: US 2026/0220787 A1
(43) Pub. Date: Jul. 30, 2026

(54) MOTION VECTOR ESTIMATION BY REFRACTIVE SURFACES USING LIGHT TRANSPORT SIMULATION

(71) Applicant: NVIDIA Corporation, Santa Clara, CA (US)

(72) Inventors: Maksim AIZENSHTEIN, Sammamish, WA (US); Steffen ECKERT-WIEWEL, Zurich (CH); Pawel KOZLOWSKI, Truckee, CA (US)

(73) Assignee: NVIDIA Corporation, Santa Clara, CA (US)

(21) Appl. No.: 19/036,981

(22) Filed: Jan. 24, 2025

(51) Int. Cl. G06T 7/20; G06T 7/70; G06T 15/06; G06T 15/20

(52) U.S. Cl. CPC G06T 7/20; G06T 7/70; G06T 15/06; G06T 15/20

(57) ABSTRACT

In various examples, systems and methods are disclosed relating to approximating motion vectors for refractive surfaces. One or more circuits can identify an object and a refractive surface of a simulated scene. The one or more circuits can generate, based at least on a ray of a ray tracing process, a transformation data structure for the object relative to the refractive surface. The one or more circuits can determine a position in the simulated scene depicted by an image representing the object appearing behind the refractive surface based at least on the transformation data structure. The one or more circuits can render a frame of the simulated scene according to the position of the image representing the object.

### BACKGROUND

Motion vectors can represent the displacement of pixels between consecutive rendered frames, facilitating techniques such as temporal anti-aliasing and denoising. Conventional approaches to estimating motion vectors are limited to opaque surfaces and struggle to accurately approximate vectors for objects obscured by curved, refractive surfaces. Such limitations lead to inaccuracies in rendering, particularly in scenarios involving complex refraction and reflection.

### SUMMARY

In computer graphics, motion vectors represent the displacement of pixels between consecutive frames, facilitating techniques such as temporal anti-aliasing and denoising. Conventional methods for estimating motion vectors are limited to opaque surfaces, which restricts the applicability of these techniques in scenes containing transparent or reflective materials. Such materials, particularly when curved, introduce complexities due to refraction and reflection, leading to inaccuracies in motion vector estimation. The techniques described herein address these limitations by extending the thin lens approximation to accurately estimate motion vectors for objects obscured by curved refractive surfaces. This approach involves representing each refractive interface as a linear operator in projective space, allowing for the precise calculation of how light rays bend as they pass through these surfaces.

To implement the described techniques, a system in accordance with one or more embodiments of the present disclosure can determine a lens transfer matrix at at least one (e.g., each) refractive interface encountered during a ray tracing process. This matrix can be generated based on one or more of a surface curvature, medium properties, and the angle of the traced ray relative to the surface hit point. During traversal, the system can chain these transformations, multiplying the transformation matrices for each of the at least one interface, and finally, performing perspective division. This method allows for the accurate approximation of motion vectors even in complex scenes with multiple curved refractive interfaces. The techniques described herein can be used to determine respective image positions of objects that appear behind refractive surfaces, which can be used to facilitate the accurate approximation of motion vectors for those objects.

At least one aspect relates to one or more processors. The one or more processors can include one or more circuits. The one or more circuits can identify an object (e.g., behind a refractive surface) and a refractive surface of a simulated scene (e.g., to be rendered). The one or more circuits can generate, based at least on one or more samples of light paths in the simulated scene, a transformation data structure (e.g., matrix) for the object relative to the refractive surface. The one or more circuits can determine, based at least on the transformation data structure, a position of an image (e.g., a position in the simulated scene depicted by the image) representing the object as appearing behind the refractive surface. The one or more circuits can process a frame of the simulated scene based at least on a motion vector generated according to the position of the image representing the object.

In some implementations, the frame is a first frame, and the position in the simulated scene depicted by the image is a first position of a first image. In some implementations, the one or more circuits can determine a second position depicted in the scene depicted by a second image representing the object in a second frame (e.g., a subsequent frame) using a second transformation data structure (e.g., a second matrix for the refractive surface in the second frame). In some implementations, the one or more circuits can generate a motion vector for one or more pixels of the second frame based on a position of the object in the first frame and the second transformation data structure. In some implementations, the position of the object is a first position of the object. In some implementations, the one or more circuits can generate the second transformation data structure according to a second position of the object in the simulated scene, the second position of the object being a different position from the first position of the object.

In some implementations, the one or more circuits can determine a distance to a center point of the refractive surface from a local region of the refractive surface. In some implementations, the one or more circuits can generate the transformation data structure based at least on the center point. In some implementations, the one or more circuits can determine the distance to the center point according to a curvature of the local region (e.g., proximate to intersection with the ray) of the refractive surface. In some implementations, at least one light path sample intersects the refractive surface at an intersection point. In some implementations, the one or more circuits can determine the curvature of the local region according to one or more vertices of the refractive surface proximate to the intersection point.

In some implementations, the one or more circuits can generate the transformation data structure according to a refractive index of the refractive surface. In some implementations, the refractive surface is a first refractive surface, and the simulated scene comprises a second refractive surface positioned between the object and the first refractive surface. In some implementations, the one or more circuits can generate a second transformation data structure for the second refractive surface. In some implementations, the one or more circuits can render the frame of the simulated scene according to the position of the image determined using the transformation data structure and the second transformation data structure. In some implementations, the one or more circuits can generate the position of the image further based at least on a perspective division operation.

At least one aspect relates to a system. The system can include one or more processors. The system can generate, for a first frame of a simulated scene, a first transformation data structure for an object positioned relative to a refractive surface in the simulated scene. The system can determine, using the first transformation data structure, a first position in the simulated scene depicted by an image (position in the simulated scene depicted by the image) representing the object as appearing behind the refractive surface in the first frame. The system can generate, for a second frame of the simulated scene, a second transformation data structure for an object positioned relative to the refractive surface in the simulated scene. The system can determine, using the second transformation data structure, a second position in the simulated scene depicted by the image representing the object as appearing behind the refractive surface in the second frame. The system can generate a motion vector for the object based on the first position and the second position.

In some implementations, the system can render the second frame based at least on the motion vector. In some implementations, the system can render the second frame using temporal anti-aliasing calculated using the motion vector. In some implementations, the system can determine the first transformation data structure and the second transformation data structure using a light transport simulation process. In some implementations, the system can determine a distance to a center point of the refractive surface in the first frame from a local region of the refractive surface. In some implementations, the system can generate the first transformation data structure based at least on the center point. In some implementations, the system can generate the first transformation data structure and the second transformation data structure according to a refractive index of the refractive surface.

At least one aspect is related to a method. The method can include identifying, using one or more processors, an object and a refractive surface of a simulated scene. The method can include generating, using the one or more processors, and based at least on one or more sample light paths of a light transport simulation process, a transformation data structure for the object relative to the refractive surface. The method can include determining, using the one or more processors, a position in the simulated scene depicted by an image representing the object as appearing behind the refractive surface based at least on the transformation data structure. The method can include processing, using the one or more processors, a frame of the simulated scene based at least on a motion vector generated according to the position in the simulated scene depicted by the image representing the object.

In some implementations, the frame is a first frame, the position of the image is a first position of a first image, and the method can include determining, using the one or more processors, a second position of a second image representing the object in a second frame using a second transformation data structure. In some implementations, the method can include generating, using the one or more processors, a motion vector for one or more pixels of the second frame based on a position of the object in the first frame and the second transformation data structure. In some implementations, the position of the object is a first position of the object, and the method can include generating, using the one or more processors, the second transformation data structure according to a second position of the object in the simulated scene, the second position of the object being a different position from the first position of the object.

The processors, systems, and/or methods described herein can be implemented by or included in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing generative AI operations using a large language model, a system for performing generative AI operations using a video language model, a system implemented using an edge device, a system implemented using a robot, a system for performing conversational AI operations, a system for generating synthetic data, a system incorporating one or more virtual machines (VMs), a system implemented at least partially in a data center, or a system implemented at least partially using cloud computing resources.

### BRIEF DESCRIPTION OF THE DRAWINGS

The present systems and methods for simulating refractive surfaces in ray tracing to estimate motion vectors are described in detail below with reference to the attached drawing figures, wherein:

FIG. 1 is a block diagram of an example system for simulating refractive surfaces in ray tracing to estimate motion vectors, in accordance with some embodiments of the present disclosure;

FIG. 2 depicts an example diagram showing how the location of an image representing an object positioned behind a curved and refractive surface can be determined according to a ray tracing process, in accordance with some embodiments of the present disclosure;

FIG. 3 is a flow diagram of an example of a method for simulating refractive surfaces in ray tracing to estimate motion vectors, in accordance with some embodiments of the present disclosure;

FIG. 4 is a block diagram of an example computing device suitable for use in implementing some embodiments of the present disclosure; and

FIG. 5 is a block diagram of an example data center suitable for use in implementing some embodiments of the present disclosure.

### DETAILED DESCRIPTION

This disclosure relates to systems and methods for estimating motion vectors for objects obscured by transparent materials that cause refraction of ray-traced beams. In computer rendering, ray tracing is one of a class of light transport simulation techniques-along with path tracing, ray marching, ray casting-used to generate realistic images by simulating the way light interacts with objects in a virtual scene. Ray tracing (and other light transport simulation techniques) accounts for the material properties of the objects in a scene and can simulate the way light interacts with surfaces of objects that include reflective or refractive materials. If the surface of an object is reflective or transparent, recursive ray tracing can be performed to trace how light reflects off or passes through the object.

Conventional rendering algorithms can use screen space motion vectors to temporally integrate pixels for rendering techniques such as high-quality anti-aliasing (AA) or denoising using Monte-Carlo (MC) approaches. Such conventional approaches operate by calculating motion vectors for opaque surfaces within (spatial motion vectors) or between (temporal motion vectors) frames. Although certain implementations may be used to approximate motion vectors for a refractive and/or reflective surface exist, such implementations are typically limited only to estimating motion vectors for large, flat surfaces. Such approaches cannot be used to approximate motion vectors for curved, refractive/reflective surfaces.

To address these limitations, the systems and methods described herein make use of the thin lens equations to approximate curved interfaces. Ray tracing (and other suitable light transport simulation techniques) performed according to the techniques described herein can be used to accurately approximate motion vectors for objects that appear behind curved refractive surfaces. Additionally, these ray tracing approaches can be used to accurately perform recursive ray tracing for multiple curved refractive interfaces in a simulated scene. The approximation of rays passing through refractive surfaces also does not suffer from disocclusion of screen space data, unlike some conventional approaches.

Implementing these ray tracing techniques involves exploiting a property of the thin lens operator, which is a linear operator in projective space. In at least one embodiment of the present disclosure, at least one (e.g., each) refractive interface in a simulated scene can be represented by a linear operator (e.g., a transformation matrix) for which perspective division is to be applied. Perspective division can be performed after chaining the transformations of multiple interfaces, as a transformation for each of the at least one interface can be represented in matrix format. Chaining multiple interfaces includes multiplying transformation matrices for each of the at least one interface and performing perspective division as the final operation. A path through all of the at least one refractive interfaces (e.g., every refractive interface) in a scene can therefore be represented using a single linear operator in projective space.

Refraction can be accurately approximated by determining a position in the simulated scene depicted by an image corresponding to an object that appears behind one or more refractive interfaces in a scene. At each refractive interface in the scene that is intersected by a ray during ray tracing, a lens transfer matrix is then generated according to position(s) of any object(s) behind the refractive interface. The lens transfer matrix can be transformed to a local coordinate system of the hit surface, with one of the coordinate axes corresponding a normal of the local surface of the refractive interface.

Similar transformations can be repeated for each refractive interface appearing between the viewer (e.g., a camera) and the object that is subject to ray tracing. The position of the image (e.g., the location that the object appears in the refractive surface) for rendering can be determined by performing this chain of transformations and subsequently performing perspective division. Changes in the position of the image across multiple sequential frames can be used to determine screen space motion vectors for the object in the simulated scene.

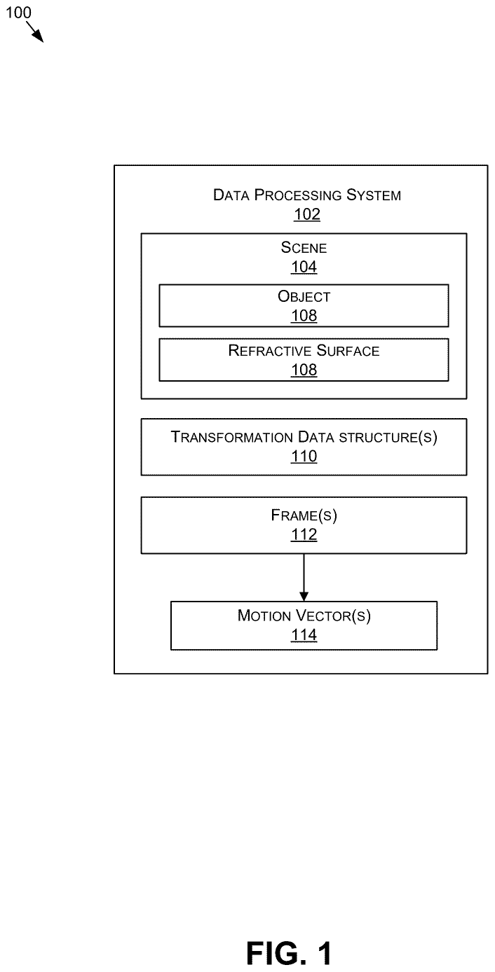

With reference to FIG. 1, FIG. 1 is an example computing environment including a system 100 for simulating refractive surfaces in ray tracing to estimate motion vectors, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The system 100 is shown as including a data processing system 102. The data processing system 102 can include at least one processor and a memory (e.g., one or more processing circuits). The memory can store processor-executable instructions that, when executed by processor, cause the processor to perform one or more of the operations described herein. The processor may include a microprocessor, an application-specific integrated circuit (ASIC), a field-programmable gate array (FPGA), a graphical processing unit (GPU), or combinations thereof. The memory may include, but is not limited to, electronic, optical, magnetic, or any other storage or transmission device capable of providing the processor with program instructions. The data processing system 102 can include one or more computing devices or servers that can perform various functions as described herein. In one example, the data processing system 102 is a computing system that includes one or more GPUs that render frames 112 of a simulated scene 104 using ray tracing techniques that approximate motion of objects 106 relative to refractive surfaces 108 in the simulated scene 104.

The scene 104 can include a simulated, three-dimensional (3D) environment including one or more 3D models (e.g., the objects 106, entities/objects/features having refractive and/or reflective surfaces 108, etc.) having various locations, attributes, textures, or other features. The scene 104 can be rendered by the data processing system 102 according to the techniques described herein to generate one or more frames 112. In one example, the scene 104 can be provided or otherwise updated by one or more applications executed using the data processing system 102. For example, the applications may include 3D gaming applications, 3D modeling applications, or other types of 3D applications that involve rendering of one or more objects 106 and/or refractive surfaces 108.

The simulated scene 104 can include one or more objects 106. The simulated scene 104 can include any number of objects 106. Objects 106 within a simulated scene 104 can be positioned at any location within the scene 104 and may have any 3D orientation. The objects 106 can include one or more of, for example and without limitation: 3D models, texture data, or other attributes. The objects 106 can may include 3D mesh assets, which may represent any type of object, entity, or graphical feature within the scene 104. Objects 106 may include additional assets/data that corresponding to the visual characteristics of the objects 106, including but not limited to textures, materials, or patterns, among other assets. The objects 106 may include information corresponding to texture/material mapping, which can indicate to which polygons different textures, materials, or patterns are to be mapped.

The textures of an object 106 may include digital image files (e.g., PNG, JPEG, HDR, EXR, etc.), or any other type of two-dimensional (2D) images that are mapped to the surface of the object 106. Materials for an object 106 can be used to define the appearance of the model, such as its color, reflectiveness, transparency, or refractive index, among other properties. In some implementations, one or more polygons of an object 106 to which a transparent/refractive index is mapped can be part of a refractive surface 108. In some implementations, materials of an object 106 can be used to create a variety of different effects, such as making the object 106 appear like metal, plastic, or wood. The materials for an object 106 may include one or more one or more material definition language (MDL) files, in some implementations. In some implementations, the materials may be represented as textures with additional properties, like normal maps, specularity (e.g., reflectance), index of refraction, transparency, or specular colors, among others.

In some implementations, objects 106 may include pattern data. Pattern data can include or may specify predetermined texture patterns or may include instructions to define (e.g., draw) one or more predetermined or generated patterns on a surface of object 106. Patterns may define one or more gradients between colors or may define a predetermined mapping of different colors to different regions of one or more polygons of an object 106. In some implementations, objects 106 may include a combination of one or more textures, materials, and/or patterns that map to corresponding polygons of a 3D mesh. An object 106 may be stored in memory of the data processing system 102 as a file or a group of files. Objects 106 within a scene can be accessed from memory of the data processing system 102 and rendered according to the techniques described herein.

A simulated scene 104 and/or one or more objects 106 can include one or more reflective surfaces 108. Refractive surfaces 108 can be groups of polygons that are defined as being transparent and having a specified refractive index. Refractive surfaces may be defined as part of one or more objects 106 or as part of mesh data of the scene 104. In some implementations, the reflective surfaces 108 may include information corresponding to texture/material mapping, which can indicate to which polygons different textures, materials, or patterns are to be mapped. The refractive surfaces 108 can include material properties that define the appearance of the model/object 106 that includes the refractive surfaces 108, such as its color, reflectiveness, transparency, or refractive index, among other properties.

When rendering a scene 104, the data processing system 102 can apply the material properties to simulate the refractive/reflective behavior of the surfaces 108, thereby affecting the way light interacts with and reflects off these surfaces 108 and how objects 106 positioned behind the refractive surfaces 108 appear. In some implementations, the refractive surfaces 108 can be part of complex 3D objects 106, where the polygons that form these surfaces 108 are mapped with materials that specify a high level of refractiveness and/or reflectiveness, such as transparent and/or glossy materials. The data processing system 102 can then use these material definitions to accurately simulate the reflection of light off these surfaces 108 according to the techniques described herein.

The data processing system 102 access manage the dynamic changes in the scene 104, including the movement of objects 106 or changes in lighting conditions, which can affect how the objects 106 and the reflective surfaces 108 of the scene 104 are rendered. For example, the data processing system 102 may update the positions/orientation of one or more objects 106 in a scene according to instructions of an application that provides the scene 104. In some implementations, the data processing system 102 can adjust the lighting conditions within the scene 104, such as the intensity, color, or direction of light sources, which can significantly alter the appearance of objects 106 and reflective surfaces 108. In some implementations, the data processing system 102 can perform these updates in real-time or at predefined intervals, such as between or in parallel with rendering of each of the frames 112.

The scene 104 can include information relating to sources of light and information indicating the position and orientation of a camera. The camera can be a virtual viewpoint from which the scene 104 is rendered. The data processing system 102 can modify the position and orientation of the camera to provide different perspectives of the scene 104. The data processing system 102 can adjust the position and orientation of the camera based on user input (e.g., input to an application providing the scene 104) or according to instructions of the application providing the scene 104. In some implementations, the camera can have a predetermined field of view (FOV) that defines the extent of the scene 104 that is visible in each frame 112. The data processing system 102 can adjust the FOV of the camera according to predetermined configuration settings and/or user input, in some implementations.

The data processing system 102 can render the scene 104 to generate a corresponding frame 112. The frame 112 can be a 2D image that represents a view of the scene 104 from a specific viewpoint, such as the position and orientation of a camera within the scene 104. The data processing system 102 can perform ray tracing to simulate the interaction of light with objects 106 and reflective surfaces 108 in the scene 104, thereby generating realistic frames 112 that accurately depict the appearance of the scene 104. The data processing system 102 can generate multiple frames 112 in sequence that can be displayed a video output of the application providing scene 104. The data processing system 102 can use pixel data of one or more of the rendered objects 106 in sequential frames to generate screen-space motion vectors 114 for the objects, which may be used to perform temporal anti-aliasing or denoising, in some implementations.

The camera may be positioned within the scene 104 such that, within the FOV of the camera, one or more objects 106 are positioned behind one or more refractive surfaces 108. As described herein, conventional approaches cannot accurately approximate the position of objects 106 behind refractive surfaces 108 over time in real-time graphics rendering. To address these limitations, the data processing system 102 can apply a thin lens approximation to accurately simulate the refraction of light as it passes through the refractive surfaces 108. The data processing system 102 can generate a linear operator to represent the refraction of each refractive surface 108. The linear operator can be stored in memory of the data processing system 102 as a transformation data structure 110 for the refractive surface 108.

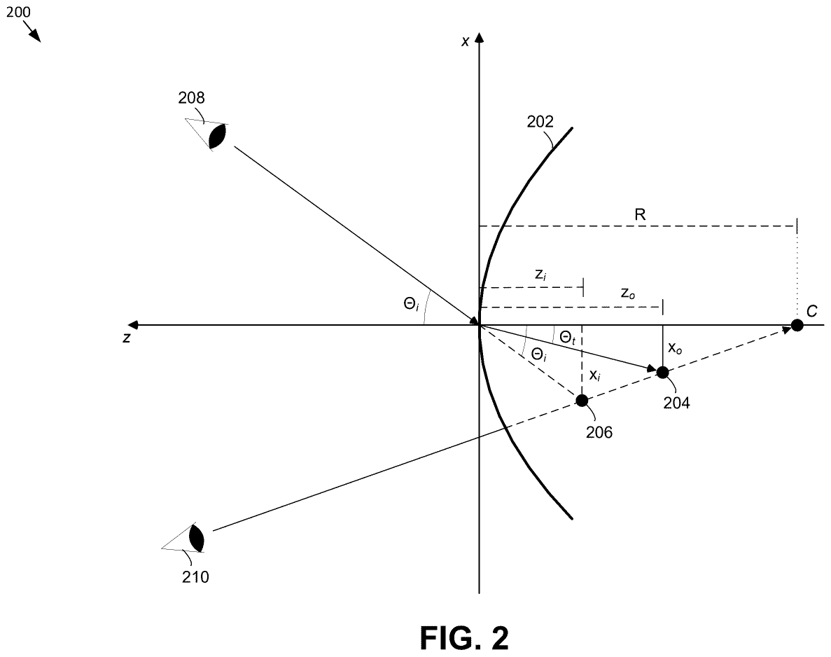

The transformation data structure 110 can be stored as a transformation matrix, in some implementations. The transformation data structure 110 can model the refraction of light rays passing through the interface of the refractive surface 108. In implementations where the FOV of the camera of the scene 104 is to capture multiple refractive surfaces 108, a respective transformation data structure 110 can be generated for each refractive surface. As the transformation data structures 110 are linear operators, the data processing system 102 can chain (e.g., multiply) multiple transformation data structures 110 for each refractive surface 108 to approximate the refraction of light rays through multiple refractive surfaces 108. An example derivation of a transformation data structure 110 for a refractive surface 108 is described in connection with FIG. 2.

Referring now to FIG. 2 in the context of the components described in connection with FIG. 1, depicted is an example diagram 200 showing how the location of an image 206 representing an object 204 (e.g., an object 106) positioned behind a curved, refractive surface 202 (e.g., a refractive surface 108, sometimes referred to as a refractive interface 202) can be determined according to a ray tracing process, in accordance with some embodiments of the present disclosure. The diagram 200 is shown as a 2D cross section of a dimensional area, x and z axes shown, with the y axis extending out of the image. The diagram 200 shows a first ray extending from a first view 208, which may be performed, in one example, as part of a ray-tracing process.

In an example ray tracing process, the first view 208 may be a virtual camera used to render a scene (e.g., a scene 104) including an object 204 positioned behind a refractive surface 202. In the example ray tracing process, rays are cast from the first view 208 (e.g., through each pixel of the virtual screen/frame to be rendered) into the scene to detect intersections with objects within the scene (e.g., an object having a refractive surface 202, an opaque object 204, etc.). When a ray intersects an object 204, the material properties of the object are used to determine how the ray (e.g., light) interacts with the object. For example, if the object is opaque, the ray may stop, while if the object is transparent/refractive, the ray may be bent. In this example, the ray extending from the first view 208 begins at angle Θᵢ relative to the z axis, and then is bent according to the value

$$η = \frac{{n}_{2}}{{n}_{1}}$$

to the angle Θₜ relative to the z axis, where the value n₂ is the index of refraction of the refractive surface 202 and the value n₁ is the index of refraction of the medium between the first view 208 and the refractive surface 202. In some implementations, the value of Θₜ can be determined using Snell's law.

The refracted ray extending from the view 208 intersects with the object 204, indicating that the object 204 is to appear within the frame rendered via the view 208. Due to difference between an index of refraction n₂ of the refractive surface 202 and the index of refraction n₁ of the surrounding medium (each of which may be predetermined values and/or properties of the scene 104 or objects 106 thereof), the object 204, shown here at (xₒ, zₒ), is to appear in the first view 208 at the position of the image 206, shown here as (xᵢ, zᵢ). This is because refractive surfaces 202 distort the positions of objects/features positioned behind them with respect to a viewer, with the distortion being a function of the differences between the index of refraction of the refractive surface 202 and its surrounding medium.

The position of the image 206 can be estimated using a thin lens approximation. During a ray tracing process, the refractive surface 202 can be modeled as a thin lens with a local curvature κₙ The curvature κₙ of the refractive surface 202 can be determined/estimated/approximated based at least on the set of polygons defining the portion of refractive surface 202 proximate to the location that a ray intersects the refractive surface 202. In the approximation described herein, the local curvature κₙ using any suitable process, including but not limited to fitting a local surface to the intersection point and the vertices of the refractive surface 202 proximate to the intersection point, where the coefficients of the fitted surface can be used to compute the curvature. Other techniques, including derivative-based techniques applied to vertices of the refractive surface 202, may also be used.

In this example, the local surface properties (e.g., the local curvature κₙ) of the refractive surface 202 are the local surface properties are extrapolated to be global. As the curvature κₙ approximates the refractive surface 202 proximate to the intersection point as a portion of a sphere, the radius R of the sphere defined by the curvature κₙ can be defined as

$$R = \frac{1}{{κ}_{n}} .$$

In this example, the intersection between the ray being traced and the refractive surface 202 is used as the origin of the frame of reference, such that the location of the center point C of the sphere defined by the local curvature κₙ can be set to R along the z axis.

In this approximation, the refractive surface 202 is approximated as a virtual lens. Using this approximation, the position of the image 206 with respect to the first view 208 can be approximated as the intersection between the ray extending from the first view 208 and a helper ray extending from a second view 210. Note that the helper ray is not generated during a ray tracing process and is instead used to facilitate depiction of the derivation of the thin lens approximation for refractive surfaces. The helper ray extending from the second view 210 is a ray that would capture the object 204 without the helper ray changing its direction due to refraction via the refractive surface 202. As such, from the perspective of the second view 210, the position of the image 206 and the object 204 are placed on the same line.

The position of the image 206 representing the object 204 from the perspective of the first view 208 can be determined as the intersection point between the first ray and the helper ray, if the first ray were not refracted according to the differences between the indices of refraction of the refractive surface 202 and the surrounding medium. To approximate this difference, a transformation data structure (e.g., a transformation data structure 110) can be generated that transforms the position of the object 204 to the position of the image 206 with respect to the first view 208.

The transformation data structure M for an intersection between a ray and a refractive surface can be generated to orient the coordinate system to align with the normal of the refractive surface 202 at the refraction/reflection point, can apply a lens transfer matrix, and can restore the previous coordinate system. An example representation of a transformation data structure is provided below:

$$M = P L {P}^{- 1}$$

In the above equation, the M refers to the transformation data structure for the intersection at the refractive surface 202, P is a transformation matrix that transforms the current coordinate system to align with the normal of the refractive surface 202 at the intersection point, L is a lens transfer matrix that calculates a refracted position (e.g., the position of the image 206) when applied to a position of the object 204, and P⁻¹ is the inverse of P that transforms the coordinate system back to its original state. The lens transfer matrix L can have elements that can be represented/calculated as a function of the angles Θᵢ, Θₜ, and/or the division of the indices of refraction η. An example representation of a lens transfer matrix L is provided below:

$$L = ( \begin{matrix}{λ}_{1} & 0 & 0 & 0 \\ 0 & {λ}_{1} & 0 & 0 \\ 0 & 0 & {λ}_{2} & 0 \\ 0 & 0 & \frac{{λ}_{1} - {λ}_{2}}{R} & {λ}_{1}\end{matrix} )$$

In the above equation, the value λ₁ is equal to Θ*cos Θₜ, the value λ₂ is equal to cos Θᵢ, and the value R represents the distance to the circle extrapolated from the local curvature κₙ of the refractive surface 202 and is equal to

$$\frac{1}{{κ}_{n}} .$$

The transformation data structure can be applied to the position of the object 204 to transform the position of the object to the position of the image, approximating the appearance of refraction through the curve refractive surface 202. Perspective division can then be applied to convert the homogeneous coordinates of the object 204 to normalized device coordinates for rendering. An example representation of applying the transformation matrix is provided below:

$${x}_{p} = \frac{M x}{w M x}$$

In the above equation, xₚ are the coordinates of the image 206 representing the object 204 following application of the transformation data structure and perspective division, M is the transformation data structure, and x is the initial coordinates of the object intersected by the ray during the ray tracing process.

This approach can also be used to approximate the refraction caused by multiple intervening refractive surfaces 202 positioned between the first view 208 and the object 204. To do so, a combined transformation data structure M′ can be generated that includes the transformation data structures M generated for each intervening refractive surface 202. In one example, the combined transformation data structure M′ can be generated according to the equation below:

$${M}^{′} = I d \prod {P}_{i} {L}_{i} {P}_{i}^{- 1} = I d \prod {M}_{i}$$

In the above equation, M′ refers to the combined transformation data structure, Id refers to the identity matrix (e.g., a four-dimensional (4D) identity matrix, etc.), Pᵢ is a transformation matrix that transforms the current coordinate system to align with the normal of the ith refractive surface 202 at the intersection point with the ray, Lᵢ is the lens transfer matrix of the ith refractive surface 202, and

$${P}_{i}^{- 1}$$

is the inverse of Pᵢ that transforms the coordinate system back to its original state. In this example, the ith transformation data structure for the ith refractive surface 202 is provided as Mᵢ.

This approach represents each of the refractive surfaces 202 with a linear operator (e.g., the transformation data structure Mᵢ) for which perspective division is to be applied. However, as the transformation data structures can be applied through multiplication, perspective division be performed once after all transformation data structures Mᵢ are applied. This enables all refractive surfaces to be represented using a single linear operator in projective space, M′. An example equation to apply the combined transformation data structure is as follows:

$${x}_{p} = \frac{{M}^{′} x}{w {M}^{′} x}$$

In the above equation, xₚ are the coordinates of the image 206 representing the object 204 following application of the transformation data structure and perspective division, M′ is the combined transformation data structure, x is the initial coordinates of the object intersected by the ray during the ray tracing process, and wM′x represents the perspective division.

Referring back to FIG. 1, the data processing system 102 can render one or more frames 112 of the scene using a ray tracing process that implements the approaches described in connection with FIG. 2. For example, the data processing system can trace rays according to the field of view of the camera to generate pixel data for each pixel of a frame 112. Using the approaches described in connection with FIG. 2, the data processing system 102 can generate transformation data structures 110 for each refractive surface 108 that traced rays intersect with. The transformation data structures 110 can automatically be generated and applied to objects 106 in the scene 104 that are intersected after passing through intersection by a refractive surface 108.

The data processing system 102 can render the scene 104, including any objects 106 and/or refractive surfaces 108 within the FOV of the camera, to generate one or more frames 112. Rendering the frames can be performed using any suitable ray tracing process, which can include the use of transformation data structures 110 to determine the image position of objects 106 behind refractive surfaces 108 in current and previous frames. The image positions can then be used to determine motion vectors for the objects 106. The ray tracing process may involve casting rays for each screen space pixel of a frame 112 into the scene to identify world positions of each hit. The data processing system can generate a view-projection matrix to map 3D world points corresponding to hits by each ray into the 2D screen space of the frame 112 to be rendered. The data processing system 102 can store the view-projection matrix in association with the frame 112. The data processing system 102 can also store various state transformations (e.g., velocity, etc.) of each object 106, refractive surface 108, and/or the camera of the scene 104 in association with each frame 112.

Through the use of the transformation data structures 110 described herein, the data processing system 102 can render the frames 112 such that the color information of the objects 106 appear at pixel locations corresponding to the transformed position (e.g., the image position generated by applying the transformation data structures 110) of the object 106 due to refraction via the refractive surface 108. The motion vectors generated according to the techniques described herein can be used by denoiser functions, temporal antialiasing functions, or other functions that can improve image quality.

As described herein, the scene 104 can be provided and/or generated by a 3D application, such as a 3D gaming application, a 3D design application, or any other type of application that implements 3D ray tracing to render frames 112. The data processing system 102 can receive and/or access information for rendering a scene 104 via the application and can render sequences of frames 112 to depict changes in the scene 104 over time. In an example where the application is a 3D interactive application, frames 112 can be rendered by the data processing system 102 according to a frame rate, with the scene 104 being updated between generation of each sequential frame 112. The scene 104 may be updated to modify any portion of the scene, including but not limited to the position/orientation of the camera, the position/orientation of one or more objects 106, and/or the position/orientation of one or more refractive surfaces 108, among any other updates/state changes.

The data processing system 102 can render each frame 112 to display the changes to the scene that occurred relative to a previously generated frame 112. In rendering the frames 112, the data processing system 102 can track/store the location of each ray/point captured for a given frame. For rays that intersect one or more refractive surfaces 108 and subsequently intersect with an object 106, the position for that ray can be captured as the image position generated using the transformation data structure 110, as described herein. The positions of pixels corresponding to each ray can be tracked between frames to calculate screen space motion vectors 114 for each pixel. As the transformation data structures 110 are used to calculate a global approximation by extrapolating local surface properties of refractive surfaces 108, the motion of objects 106 relative to refractive surfaces 108 can be accurately approximated and used to generate screen space motion vectors 114 that do not suffer from disocclusion of screen space pixel data.

The data processing system 102 can calculate screen motion vectors 114 by capturing and storing data (e.g., hit position, normal, depth, material properties, etc.) corresponding to each ray that intersects with an object 106 in each frame 112 that is rendered. For each pixel in screen space that corresponds to a ray that intersected with an object 106, the data processing system 102 can determine the world position (e.g., the transformed image position generated using the transformation data structure 110, if the object 106 is positioned behind a refractive surface 108, etc.) of the ray hit. Using transformation information (e.g., velocity information, the transformation data structure 110, etc.) of the camera, each object 106, and/or each refractive surface 108, and any other feature of the scene 104, the data processing system 102 can calculate where the hit point would have occurred in a prior frame 112 in world-space coordinates.

The data processing system 102 can then calculate the screen space coordinates of the point for the previous frame 112. In some implementations, the data processing system 102 can use a view-projection matrix used to render the previous frame 112 in screen space. This provides a screen space coordinate at which the hit point of the current frame 112 would have appeared in the previous frame 112. In some implementations, other approaches may be used to calculate the screen space coordinates using other techniques, such as approaches specific to fisheye cameras, among others. The data processing system 102 can then calculate a screen space motion vector 114 for each pixel in the current frame 112 being rendered by subtracting the screen space position of each hit as it would have appeared in the previous frame 112 from the screen space position of each hit in the current frame 112. The motion vector 114 can be a two-dimensional vector that encode how much the pixel has moved between sequential frames 112.

The data processing system 102 can calculate motion vectors 114 for each frame 112 during the rendering process. In some implementations, the data processing system 102 can store screen motion vectors 114 for each pixel of the current frame 112 in a motion vector texture or another type of motion vector data structure. The motion vectors 114 can be used to generate effects such as motion blur, temporal anti-aliasing, and/or denoising for the current frame 112. The data processing system 102 can apply the effects to the current frame 112 prior to rendering/display via a display device of the data processing system 102. In some implementations, the data processing system 102 can include a display device that presents each rendered frame 112. In some implementations, the data processing system 102 can be a server operating in a streaming environment and can transmit rendered frames (e.g., with suitable video/audio encoding, etc.) to one or more client devices via a network.

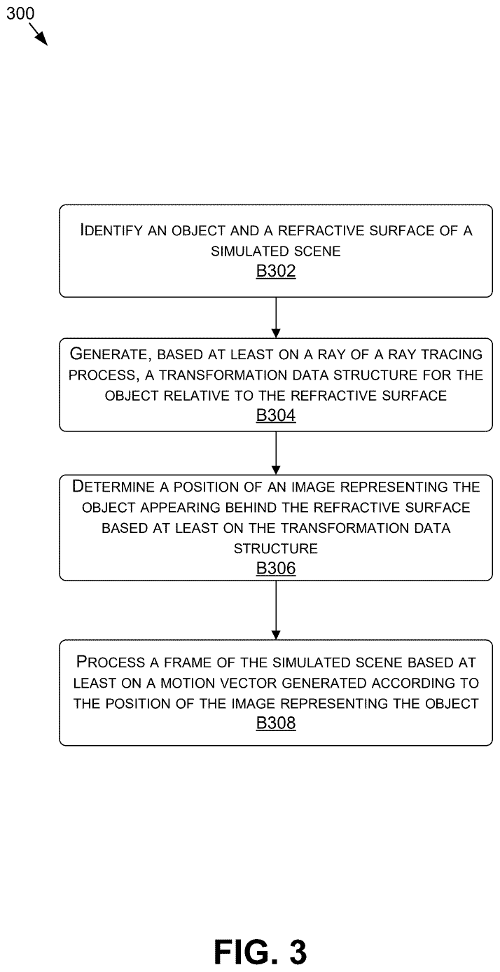

Now referring to FIG. 3, each block of method 300, described herein, includes a computing process that may be performed using any combination of hardware, firmware, and/or software. For instance, various functions may be carried out by one or more processors executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the system of FIG. 1. However, this method may additionally or alternatively be executed by any one system, or any combination of systems, including, but not limited to, those described herein.

FIG. 3 is a flow diagram showing a method 300 for simulating refractive surfaces in ray tracing to estimate motion vectors, in accordance with some embodiments of the present disclosure. The method 300, at block B302, includes identifying an object (e.g., an object 106) and a refractive surface (e.g., a refractive surface 108) of a simulated scene (e.g., a scene 104). The object can be identified from an application providing the simulated scene, which may include a 3D gaming application, a 3D design application, or any other type of application that may implement ray tracing. The refractive surface and object can be identified during a ray tracing process, for example, based on hit information generated by casting a ray through the simulated scene. In one example, the object can be positioned behind one or more refractive surfaces relative to a camera of the simulated scene.

The method 300, at block B304, includes generating, based at least on a ray of a ray tracing process, a transformation data structure (e.g., the transformation data structure 110) for the object relative to the refractive surface. The transformation data structure can be generated to include a transformation matrix for each refractive surface through which the ray intersected prior to intersecting with the object. The transformation data structure may be generated by multiplying multiple transformation matrices each corresponding to a respective refractive surface of the simulated scene. The transformation data structure can be generated using any of the techniques described herein in connection with FIGS. 1 and 2.

The method 300, at block B306, includes determining a position in the simulated scene depicted by an image (e.g., the image 206) representing the object appearing behind the refractive surface based at least on the transformation data structure. The image can be a position in world space of the simulated scene at which the object is to appear given the refraction caused by the refractive surface(s) between the camera and the object. The position of the image can be calculated/determined by multiplying the transformation data structure by the word position coordinates of the intersection point between the ray and the object and subsequently performing perspective division. The result of the perspective division can be stored as the position of the image that represents the object in word space (e.g., 3D space within the simulated scene).

The method 300, at block B308, includes processing a frame of the simulated scene based at least on a motion vector generated according to the position of the image representing the object. The frame can be processed following rendering of the frame, for example, using generated motion vectors to implement denoising or anti-aliasing techniques, in some implementations. Rendering the frame can include determining and/or applying a view-perspective matrix to convert the world space positions of each ray hit (which may include image positions generated at block B306) into 2D screen space coordinates. The screen space coordinates of the current frame, as well as transformation information of prior frames, can be used to calculate motion vectors for each rendered frame. The motion vectors can include accurate approximations of movement of objects behind refractive surfaces. The motion vectors can be used to apply effects such as motion blur, de-noising, and temporal anti-aliasing to the rendered frame, as described herein.

The systems and methods described herein may be used for a variety of purposes, by way of example and without limitation, for circuit layout definition, machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational artificial intelligence (AI), light transport simulation (e.g., ray-tracing, path tracing, etc.), collaborative content creation for three-dimensional (3D) assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models-such as one or more large language models (LLMs), systems for performing light transport simulation, systems for performing collaborative content creation for 3D assets, systems implemented at least partially using cloud computing resources, and/or other types of systems.

Approaches in accordance with various embodiments can be used to generate one or more parameters for a content generation environment. In at least one embodiment, a trained machine learning (ML) and/or artificial intelligence (AI) system, such as a large language model (LLM) or a vision language model (VLM), may be used to generate parameters for the content generation environment, such as, but not limited to, camera settings, scene lighting, video parameters, and/or the like, used for displaying objects within a scene. The parameters may be based on an input provided by a user or a proxy for a user to a trained language model (e.g., LLM, VLM, etc.) that can then generate one or more settings in accordance with the input. Various embodiments may be used to generate settings in two-dimensional (2D) or three-dimensional (3D) settings. For embodiments that incorporate one or more language models—that is, one or more LLMs, one or more VLMs, or a combination of LLMs and VLMs, the language model(s) may receive an input (e.g., a prompt, a request, a query, etc.) that is parsed or otherwise formatted to generate a deterministic output. For example, the input provided to the language model may include a particular format for the output results, an example of desired output results, a particular list of parameters and their respective formatting, and the like. An input generator (e.g., a prompt generator), which may be driven or otherwise guided by one or more AI and/or ML systems, may be used to generate this input based on an initial input received from a user, a device, a proxy, and/or the like. A modified input generated by the input generator may then be provided to the language model, which will generate an output set of parameters. This output may be further evaluated with a reviewer, or other system, to ensure that the output is appropriate. Thereafter, a configuration file may be generated and/or the parameters may be directly provided to an environment to configure different components (e.g., camera settings, lighting, etc.) based on the parameters generated by the language model.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

### Example Computing Device

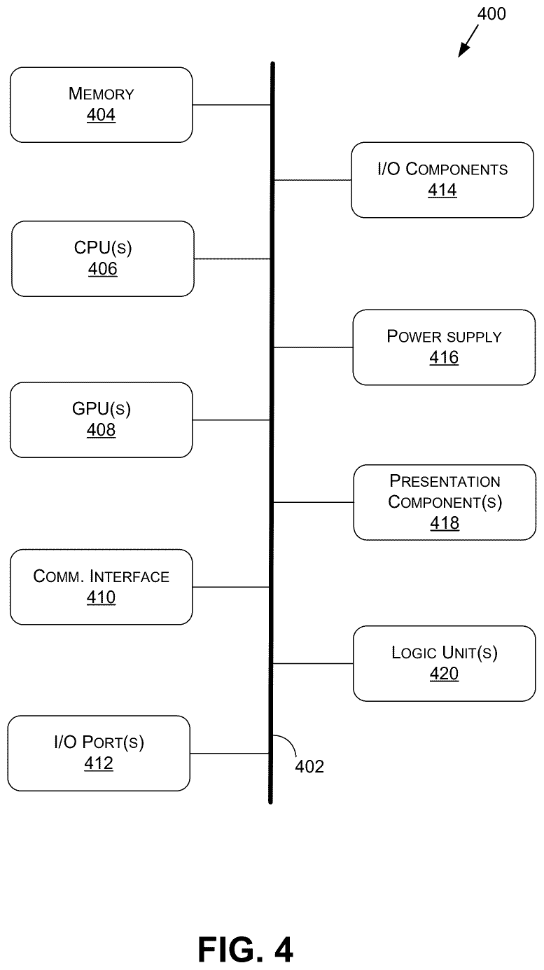

FIG. 4 is a block diagram of an example computing device(s) 400 suitable for use in implementing some embodiments of the present disclosure. Computing device 400 may include an interconnect system 402 that directly or indirectly couples the following devices: memory 404, one or more central processing units (CPUs) 406, one or more graphics processing units (GPUs) 408, a communication interface 410, input/output (I/O) ports 412, input/output components 414, a power supply 416, one or more presentation components 418 (e.g., display(s)), and one or more logic units 420. In at least one embodiment, the computing device(s) 400 may comprise one or more virtual machines (VMs), and/or any of the components thereof may comprise virtual components (e.g., virtual hardware components). For non-limiting examples, one or more of the GPUs 408 may comprise one or more vGPUs, one or more of the CPUs 406 may comprise one or more vCPUs, and/or one or more of the logic units 420 may comprise one or more virtual logic units. As such, a computing device(s) 400 may include discrete components (e.g., a full GPU dedicated to the computing device 400), virtual components (e.g., a portion of a GPU dedicated to the computing device 400), or a combination thereof.

Although the various blocks of FIG. 4 are shown as connected via the interconnect system 402 with lines, this is not intended to be limiting and is for clarity only. For example, in some embodiments, a presentation component 418, such as a display device, may be considered an I/O component 414 (e.g., if the display is a touch screen). As another example, the CPUs 406 and/or GPUs 408 may include memory (e.g., the memory 404 may be representative of a storage device in addition to the memory of the GPUs 408, the CPUs 406, and/or other components). In other words, the computing device of FIG. 4 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 4.

The interconnect system 402 may represent one or more links or busses, such as an address bus, a data bus, a control bus, or a combination thereof. The interconnect system 402 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 406 may be directly connected to the memory 404. Further, the CPU 406 may be directly connected to the GPU 408. Where there is direct, or point-to-point connection between components, the interconnect system 402 may include a PCIe link to carry out the connection. In these examples, a PCI bus need not be included in the computing device 400.

The memory 404 may include any of a variety of computer-readable media. The computer-readable media may be any available media that may be accessed by the computing device 400. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 404 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 400. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 406 may be configured to execute at least some of the computer-readable instructions to control one or more components of the computing device 400 to perform one or more of the methods and/or processes described herein. The CPU(s) 406 may each include one or more cores (e.g., one, two, four, eight, twenty-eight, seventy-two, etc.) that can handle a multitude of software threads simultaneously. The CPU(s) 406 may include any type of processor and may include different types of processors depending on the type of computing device 400 implemented (e.g., processors with fewer cores for mobile devices and processors with more cores for servers). For example, depending on the type of computing device 400, the processor may be an Advanced RISC Machines (ARM) processor implemented using Reduced Instruction Set Computing (RISC) or an x86 processor implemented using Complex Instruction Set Computing (CISC). The computing device 400 may include one or more CPUs 406 in addition to one or more microprocessors or supplementary co-processors, such as math co-processors.

In addition to or alternatively from the CPU(s) 406, the GPU(s) 408 may be configured to execute at least some of the computer-readable instructions to control one or more components of the computing device 400 to perform one or more of the methods and/or processes described herein. One or more of the GPU(s) 408 may be an integrated GPU (e.g., with one or more of the CPU(s) 406 and/or one or more of the GPU(s) 408 may be a discrete GPU. In embodiments, one or more of the GPU(s) 408 may be a coprocessor of one or more of the CPU(s) 406. The GPU(s) 408 may be used by the computing device 400 to render graphics (e.g., 3D graphics) or perform general purpose computations. For example, the GPU(s) 408 may be used for General-Purpose computing on GPUs (GPGPU). The GPU(s) 408 may include hundreds or thousands of cores that are capable of handling hundreds or thousands of software threads simultaneously. The GPU(s) 408 may generate pixel data for output images in response to rendering commands (e.g., rendering commands from the CPU(s) 406 received via a host interface). The GPU(s) 408 may include graphics memory, such as display memory, for storing pixel data or any other suitable data, such as GPGPU data. The display memory may be included as part of the memory 404. The GPU(s) 408 may include two or more GPUs operating in parallel (e.g., via a link). The link may directly connect the GPUs (e.g., using NVLINK) or may connect the GPUs through a switch (e.g., using NVSwitch). When combined together, each GPU 408 may generate pixel data or GPGPU data for different portions of an output or for different outputs (e.g., a first GPU for a first image and a second GPU for a second image). Each GPU may include its own memory or may share memory with other GPUs.

In addition to or alternatively from the CPU(s) 406 and/or the GPU(s) 408, the logic unit(s) 420 may be configured to execute at least some of the computer-readable instructions to control one or more components of the computing device 400 to perform one or more of the methods and/or processes described herein. In embodiments, the CPU(s) 406, the GPU(s) 408, and/or the logic unit(s) 420 may discretely or jointly perform any combination of the methods, processes and/or portions thereof. One or more of the logic units 420 may be part of and/or integrated in one or more of the CPU(s) 406 and/or the GPU(s) 408 and/or one or more of the logic units 420 may be discrete components or otherwise external to the CPU(s) 406 and/or the GPU(s) 408. In embodiments, one or more of the logic units 420 may be a coprocessor of one or more of the CPU(s) 406 and/or one or more of the GPU(s) 408.

Examples of the logic unit(s) 420 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 410 may include one or more receivers, transmitters, and/or transceivers that enable the computing device 400 to communicate with other computing devices via an electronic communication network, included wired and/or wireless communications. The communication interface 410 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 420 and/or communication interface 410 may include one or more data processing units (DPUs) to transmit data received over a network and/or through interconnect system 402 directly to (e.g., a memory of) one or more GPU(s) 408.

The I/O ports 412 may enable the computing device 400 to be logically coupled to other devices including the I/O components 414, the presentation component(s) 418, and/or other components, some of which may be built in to (e.g., integrated in) the computing device 400. Illustrative I/O components 414 include a microphone, mouse, keyboard, joystick, game pad, game controller, satellite dish, scanner, printer, wireless device, etc. The I/O components 414 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 400. The computing device 400 may be include depth cameras, such as stereoscopic camera systems, infrared camera systems, RGB camera systems, touchscreen technology, and combinations of these, for gesture detection and recognition. Additionally, the computing device 400 may include accelerometers or gyroscopes (e.g., as part of an inertia measurement unit (IMU)) that enable detection of motion. In some examples, the output of the accelerometers or gyroscopes may be used by the computing device 400 to render immersive augmented reality or virtual reality.

The power supply 416 may include a hard-wired power supply, a battery power supply, or a combination thereof. The power supply 416 may provide power to the computing device 400 to enable the components of the computing device 400 to operate.

The presentation component(s) 418 may include a display (e.g., a monitor, a touch screen, a television screen, a heads-up-display (HUD), other display types, or a combination thereof), speakers, and/or other presentation components. The presentation component(s) 418 may receive data from other components (e.g., the GPU(s) 408, the CPU(s) 406, DPUs, etc.), and output the data (e.g., as an image, video, sound, etc.).

### Example Data Center

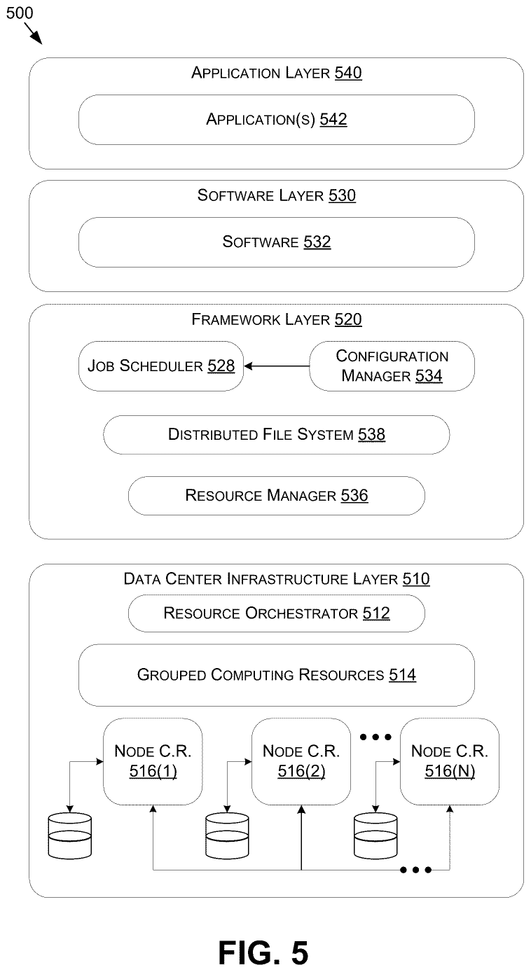

FIG. 5 illustrates an example data center 500 that may be used in at least one embodiments of the present disclosure. The data center 500 may include a data center infrastructure layer 510, a framework layer 520, a software layer 530, and/or an application layer 540.

As shown in FIG. 5, the data center infrastructure layer 510 may include a resource orchestrator 512, grouped computing resources 514, and node computing resources (“node C.R.s”) 516(1)-516(N), where “N” represents any whole, positive integer. In at least one embodiment, node C.R.s 516(1)-516(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 516(1)-516 (N) may correspond to a server having one or more of the above-mentioned computing resources. In addition, in some embodiments, the node C.R.s 516(1)-5161(N) may include one or more virtual components, such as vGPUs, vCPUs, and/or the like, and/or one or more of the node C.R.s 516(1)-516(N) may correspond to a virtual machine (VM).

In at least one embodiment, grouped computing resources 514 may include separate groupings of node C.R.s 516 housed within one or more racks (not shown), or many racks housed in data centers at various geographical locations (also not shown). Separate groupings of node C.R.s 516 within grouped computing resources 514 may include grouped compute, network, memory or storage resources that may be configured or allocated to support one or more workloads. In at least one embodiment, several node C.R.s 516 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 512 may configure or otherwise control one or more node C.R.s 516(1)-516(N) and/or grouped computing resources 514. In at least one embodiment, resource orchestrator 512 may include a software design infrastructure (SDI) management entity for the data center 500. The resource orchestrator 512 may include hardware, software, or some combination thereof.

In at least one embodiment, as shown in FIG. 5, framework layer 520 may include a job scheduler 528, a configuration manager 534, a resource manager 536, and/or a distributed file system 538. The framework layer 520 may include a framework to support software 532 of software layer 530 and/or one or more application(s) 542 of application layer 540. The software 532 or application(s) 542 may respectively include web-based service software or applications, such as those provided by Amazon Web Services, Google Cloud and Microsoft Azure. The framework layer 520 may be, but is not limited to, a type of free and open-source software web application framework such as Apache Spark™ (hereinafter “Spark”) that may utilize distributed file system 538 for large-scale data processing (e.g., “big data”). In at least one embodiment, job scheduler 528 may include a Spark driver to facilitate scheduling of workloads supported by various layers of data center 500. The configuration manager 534 may be capable of configuring different layers such as software layer 530 and framework layer 520 including Spark and distributed file system 538 for supporting large-scale data processing. The resource manager 536 may be capable of managing clustered or grouped computing resources mapped to or allocated for support of distributed file system 538 and job scheduler 528. In at least one embodiment, clustered or grouped computing resources may include grouped computing resource 514 at data center infrastructure layer 510. The resource manager 536 may coordinate with resource orchestrator 512 to manage these mapped or allocated computing resources.

In at least one embodiment, software 532 included in software layer 530 may include software used by at least portions of node C.R.s 516(1)-516(N), grouped computing resources 514, and/or distributed file system 538 of framework layer 520. One or more types of software may include, but are not limited to, Internet web page search software, e-mail virus scan software, database software, and streaming video content software.

In at least one embodiment, application(s) 542 included in application layer 540 may include one or more types of applications used by at least portions of node C.R.s 516(1)-516 (N), grouped computing resources 514, and/or distributed file system 538 of framework layer 520. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 534, resource manager 536, and resource orchestrator 512 may implement any number and type of self-modifying actions based on any amount and type of data acquired in any technically feasible fashion. Self-modifying actions may relieve a data center operator of data center 500 from making possibly bad configuration decisions and possibly avoiding underutilized and/or poor performing portions of a data center.

The data center 500 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 500. In at least one embodiment, trained or deployed machine learning models corresponding to one or more neural networks may be used to infer or predict information using resources described above with respect to the data center 500 by using weight parameters calculated through one or more training techniques, such as but not limited to those described herein.

In at least one embodiment, the data center 500 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 400 of FIG. 4—e.g., each device may include similar components, features, and/or functionality of the computing device(s) 400. In addition, where backend devices (e.g., servers, NAS, etc.) are implemented, the backend devices may be included as part of a data center 500, an example of which is described in more detail herein with respect to FIG. 5.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment- and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 400 described herein with respect to FIG. 4. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
identify an object and a refractive surface of a simulated scene;
generate, based at least on one or more samples of light paths in the simulated scene, a transformation data structure for the object relative to the refractive surface;
determine, based at least on the transformation data structure, a position in the simulated scene depicted by an image representing the object as appearing behind the refractive surface; and
process a frame of the simulated scene based at least on a motion vector generated according to the position in the simulated scene depicted by the image representing the object.

2. The one or more processors of claim 1, wherein the frame is a first frame, and the position in the simulated scene depicted by the image is a first position of a first image, and wherein the one or more circuits are to:
determine a second position in the simulated scene depicted by a second image representing the object in a second frame using a second transformation data structure; and
generate a motion vector for one or more pixels of the second frame based at least on a position of the object in the first frame and the second transformation data structure.

3. The one or more processors of claim 2, wherein the position of the object is a first position of the object, and wherein the one or more circuits are to:
generate the second transformation data structure according to a second position of the object in the simulated scene, the second position of the object being a different position from the first position of the object.

4. The one or more processors of claim 1, wherein the one or more circuits are to:
determine a distance to a center point of the refractive surface from a local region of the refractive surface; and
generate the transformation data structure based at least on the center point.

5. The one or more processors of claim 4, wherein the one or more circuits are to:
determine the distance to the center point according to a curvature of the local region of the refractive surface.

6. The one or more processors of claim 5, wherein at least one light path sample intersects the refractive surface at an intersection point, and wherein the one or more processors are to:
determine the curvature of the local region according to one or more vertices of the refractive surface proximate to the intersection point.

7. The one or more processors of claim 1, wherein the one or more circuits are to:
generate the transformation data structure according to a refractive index of the refractive surface.

8. The one or more processors of claim 1, wherein the refractive surface is a first refractive surface, and the simulated scene comprises a second refractive surface positioned between the object and the first refractive surface, and wherein the one or more circuits are to:
generate a second transformation data structure for the second refractive surface; and
render the frame of the simulated scene according to the position of the image determined using the transformation data structure and the second transformation data structure.

9. The one or more processors of claim 1, wherein the one or more circuits are to:
generate the position of the image further based at least on a perspective division operation.

10. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a large language model (LLM);
a system for performing generative AI operations using a video language model (VLM);
a system for performing generative AI operations using a multimodal language model;
a system for generating synthetic data;
a system incorporating one or more virtual machines (VMs);
a system using or deploying one or more inference microservices;
a system that incorporates one or more machine learning models deployed in a service or microservice along with an operating system (OS)-level virtualization package (e.g., a container);
a system implemented at least partially in a data center; or
a system implemented at least partially using cloud computing resources.

11. A system, comprising:
one or more processors configured to:
generate, for a first frame of a simulated scene, a first transformation data structure for an object positioned relative to a refractive surface in the simulated scene;
determine, using the first transformation data structure, a first position in the simulated scene depicted by an image representing the object as appearing behind the refractive surface in the first frame;
generate, for a second frame of the simulated scene, a second transformation data structure for an object positioned relative to the refractive surface in the simulated scene;
determine, using the second transformation data structure, a second position in the simulated scene depicted by the image representing the object as appearing behind the refractive surface in the second frame; and
generate a motion vector for the object based at least on the first position and the second position.

12. The system of claim 11, wherein the one or more processors are to:
render the second frame based at least on the motion vector.

13. The system of claim 12, wherein the one or more processors are to:
render the second frame using temporal anti-aliasing calculated using the motion vector.

14. The system of claim 11, wherein the one or more processors are to:
determine the first transformation data structure and the second transformation data structure using a light transport simulation process.

15. The system of claim 11, wherein the one or more processors are to:
determine a distance to a center point of the refractive surface in the first frame from a local region of the refractive surface; and
generate the first transformation data structure based at least on the center point.

16. The system of claim 15, wherein the one or more processors are to:
generate the first transformation data structure and the second transformation data structure according to a refractive index of the refractive surface.

17. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a large language model (LLM);
a system for performing generative AI operations using a video language model (VLM);
a system for performing generative AI operations using a multimodal language model;
a system for generating synthetic data;
a system using or deploying one or more inference microservices;
a system that incorporates one or more machine learning models deployed in a service or microservice along with an operating system (OS)-level virtualization package (e.g., a container);
a system incorporating one or more virtual machines (VMs);
a system implemented at least partially in a data center; or
a system implemented at least partially using cloud computing resources.

18. A method, comprising:
identifying, using one or more processors, an object and a refractive surface of a simulated scene;
generating, using the one or more processors, based at least on a sample light path of a light transport simulation process, a transformation data structure for the object relative to the refractive surface;
determining, using the one or more processors, a position in the simulated scene depicted by an image representing the object as appearing behind the refractive surface based at least on the transformation data structure; and
processing, using the one or more processors, a frame of the simulated scene according to the position in the simulated scene depicted by the image representing the object.

19. The method of claim 18, wherein the frame is a first frame, and the position of the image is a first position of a first image, and further comprising:
determining, using the one or more processors, a second position of a second image representing the object in a second frame using a second transformation data structure; and
generating, using the one or more processors, a motion vector for one or more pixels of the second frame based at least on a position of the object in the first frame and the second transformation data structure.

20. The method of claim 19, wherein the position of the object is a first position of the object, and further comprising:
generating, using the one or more processors, the second transformation data structure according to a second position of the object in the simulated scene, the second position of the object that is a different position from the first position of the object.
